(19) United States
(12) Patent Application Publication
(10) Pub. No.: US 2026/0113316 A1
(43) Pub. Date: Apr. 23, 2026

(54) NODE MANAGEMENT METHOD OF SERVER CHASSIS AND RELATED APPARATUS

(71) Applicant: Suzhou MetaBrain Intelligent Technology Co., Ltd., Suzhou, Jiangsu (CN)

(72) Inventors: Yong LI, Suzhou, Jiangsu (CN); Xiubo ZHANG, Suzhou, Jiangsu (CN)

(21) Appl. No.: 19/168,992

(22) PCT Filed: Dec. 6, 2024
(86) PCT No.: PCT/CN2024/137521

§ 371 Date: Sep. 25, 2025

(30) Foreign Application Priority Data
Mar. 26, 2024 (CN) 202410348297.4

(51) Int. Cl. H04L 9/40; H04L 43/0817

(52) U.S. Cl. CPC H04L 63/0876; H04L 43/0817

(57) ABSTRACT

A node management method of a server chassis and a related apparatus are provided. The node management method of the server chassis includes: acquiring, by an Ethernet switch controller provided in a server chassis, a communication request, where the server chassis further includes a plurality of chassis nodes connected to the Ethernet switch controller; identifying a request body and a target node of the communication request, where the target node is one of the plurality of chassis nodes; in response to the request body being an external node outside the server chassis, authenticating the request body, and communicating with the target node by means of a first communication mode in response to the authentication passing; and communicating with the target node by means of a second communication mode in response to the request body being the chassis node.

### CROSS-REFERENCE TO RELATED APPLICATION

This application claims priority to a Chinese Patent Application No. 202410348297.4, filed on Mar. 26, 2024 in China National Intellectual Property Administration and entitled “Node Management Method of Server Chassis and Related Apparatus”, which is hereby incorporated by reference in its entirety.

### FIELD

The present application relates to the technical field of servers, in particular to a node management method of a server chassis, a node management apparatus of a server chassis, a server chassis, a computer device, and a computer-readable storage medium.

### BACKGROUND

Generally, in many data centers and enterprise network environments, a plurality of chassis nodes such as a motherboard node and a network card node are present inside the server chassis. The plurality of chassis nodes cooperate with each other, to achieve various functions of the server, such as hardware status monitoring, power supply management, and execution of remote management operations.

Nevertheless, most of the chassis nodes are in communication connection through an Inter-Integrated Circuit (I2C) bus communication mode such as an Intelligent Platform Management BUS (IPMB), which is prone to a problem of slow rate.

### SUMMARY

The present application provides a node management method of a server chassis, a node management apparatus of a server chassis, a server chassis, a computer device, and a computer-readable storage medium.

In one aspect, a node management method of a server chassis is provided, including: acquiring, by an Ethernet switch controller provided in a server chassis, a communication request, where the server chassis further includes a plurality of chassis nodes connected to the Ethernet switch controller; identifying a request body and a target node of the communication request, where the target node is one of the plurality of chassis nodes; in response to the request body being an external node outside the server chassis, authenticating the request body, and communicating with the target node by means of a first communication mode in response to the authentication passing; and communicating with the target node by means of a second communication mode in response to the request body being the chassis node.

In one or more embodiments of the present application, the plurality of chassis nodes include a plurality of first nodes and at least one second node, where the first nodes are nodes visible to the external node, and the second node is a node hidden relative to the external node; in response to the target node being the second node, the authenticating the request body, and communicating with the target node by means of the first communication mode in response to the authentication passing includes: sending, by the Ethernet switch controller, the communication request to one of the first nodes, where the one of the first nodes serves as a forwarding node; authenticating, by the forwarding node and/or the target node, the request body; and forwarding, by the forwarding node, the communication request to the target node in response to the authentication passing.

In one or more embodiments of the present application, the authenticating, by the forwarding node and the target node, the request body includes: verifying, by the forwarding node, a first identity identifier of the request body; the forwarding node communicating with the target node by means of a third communication mode in response to the first identity identifier passing the verification; verifying, by the target node, a second identity identifier of the request body; and determining that the authentication passes in response to the second identity identifier passing the verification.

In one or more embodiments of the present application, the forwarding node communicating with the target node by means of the third communication mode includes: acquiring interface information of the request body; querying transfer configuration information, and acquiring interface information of the target node matched with the interface information of the request body, where the transfer configuration information includes pre-configured interface information of various first nodes, the second node, and the external node, as well as interface information of the target node when the first nodes, the second node, and the external node each serve as the request body; and the forwarding node communicating with the target node based on the interface information of the target node.

In one or more embodiments of the present application, the node management method includes: periodically updating the first identity identifier and the verification of the forwarding node at intervals with a first preset duration; and periodically updating the second identity identifier and the verification of the target node at intervals with a second preset duration, where the second preset duration is longer than the first preset duration.

In one or more embodiments of the present application, in response to the target node being the first node, the authenticating the request body, and communicating with the target node by means of the first communication mode in response to the authentication passing includes: receiving, by a connector port of the Ethernet switch controller, the communication request, where the connector port is a port connected to the external node; sending, by the Ethernet switch controller, the communication request from the connector port to a port connected to the target node; performing identity verification, by the target node, on the request body in response to the communication request input in a port at which the target node is connected to the Ethernet switch controller; and accepting the communication request in response to the request body passing the identity verification.

In one or more embodiments of the present application, the communicating with the target node by means of a second communication mode in response to the request body being the chassis node includes: sending, by the request body, communication data to the Ethernet switch controller; broadcasting, by the Ethernet switch controller, the communication data carrying a verified network address to the chassis node, where the verified network address includes a network address of the request body and/or a network address of the target node, and the target node is configured to acquire the communication data when the verified network address is identified; and acquiring, by the target node, the communication data in response to identifying the network address.

In one or more embodiments of the present application, the communication data includes at least one of temperature information, power consumption information, and resource utilization; the node management method includes: monitoring, by a baseboard management controller provided in the request body, operation information of the request body, where the operation information includes at least one of the temperature information, the power consumption information, and the resource utilization; and performing, by the baseboard management controller, data processing on the operation information, to obtain the communication data monitored by the baseboard management controller.

In one or more embodiments of the present application, authenticating the request body includes steps of:
determining a forwarding node for forwarding the communication request to the target node; and
authenticating the request body by the forwarding node and the target node, respectively.

In another aspect, a node management apparatus of a server chassis is provided, including: a connection interface and an Ethernet switch controller, the connection interface being configured to connect an external node, and the Ethernet switch controller being provided in the server chassis, connected to the connection interface, and configured to: acquire a communication request, where the server chassis further includes a plurality of chassis nodes connected to the Ethernet switch controller; identify a request body and a target node of the communication request, where the target node is one of the plurality of chassis nodes; communicate with the target node by means of a first communication mode in response to the request body being the external node outside the server chassis; and communicate with the target node by means of the second communication mode in response to the request body being the chassis node.

In further another aspect, a server chassis is provided, including: chassis nodes and a node management apparatus of the server chassis; the chassis nodes include a plurality of motherboard nodes and at least one network card node, and the node management apparatus is as described in the server chassis in any of the above-mentioned embodiments and connected to the chassis nodes and an external node outside the server chassis.

In one or more embodiments of the present application, the chassis nodes include a plurality of first nodes and at least one second node, the first nodes being connected to the second node, where the first nodes are nodes visible to the external node outside the server chassis, and the second node is a node hidden relative to the external node.

In one or more embodiments of the present application, a network address of each of the first nodes includes a static network address and a dynamic network address, where the dynamic network address of each of the first nodes is obtained by static allocation and/or dynamic host configuration protocol, and a network address of the second node includes a static network address.

In one or more embodiments of the present application, the Ethernet switch controller includes a first port, a second port, and a connector port; the first port is connected to the first node, the second port is connected to the second node, and the connector port is connected to a connector of a communication lead-out terminal connected to the Ethernet switch controller; the second port is configured to be in a same virtual local area network; and/or data isolation is performed between the second port and the connector port through port isolation in local area network switching.

In one or more embodiments of the present application, the first nodes include a motherboard node; the second node includes a network card node; the Ethernet switch controller includes a motherboard port, a network card port, a connector port and an idle port; the motherboard port is connected to the motherboard node; the network card port is connected to the network card node; the connector port is connected to a connector of a communication lead-out terminal connected to the Ethernet switch controller; and the idle port is configured to connect a newly added chassis node or a chassis node migrated from a port of another Ethernet switch or the connector of the communication lead-out terminal.

In one or more embodiments of the present application, the external node is connected to the server chassis through a connector of a communication lead-out terminal of the server chassis.

In one or more embodiments of the present application, the connector of the communication lead-out terminal of the server chassis is directly visible from outsides.

In one or more embodiments of the present application, the server chassis includes a plurality of internal chassis nodes, the plurality of internal chassis nodes communicating with each other through the Ethernet switch controller.

In still another aspect, a computer device is provided, including one or more processors and a memory associated with the one or more processors; the memory is configured to store a computer-readable instruction, and the following steps are implemented when the computer-readable instruction is read and executed by the one or more processors: acquiring, by an Ethernet switch controller provided in a server chassis, a communication request, where the server chassis further includes a plurality of chassis nodes connected to the Ethernet switch controller; identifying a request body of the communication request and a target node, where the target node is one of the plurality of chassis nodes; in response to the request body being an external node outside the server chassis, authenticating the request body, and communicating with the target node by means of a first communication mode in response to the authentication passing; and communicating with the target node by means of a second communication mode in response to the request body being the chassis node.

In yet another aspect, a non-transitory computer-readable storage medium is provided, having a computer-readable instruction stored therein. The following steps are implemented when the computer-readable instruction is executed by one or more processors: acquiring, by an Ethernet switch controller provided in a server chassis, a communication request, where the server chassis further includes a plurality of chassis nodes connected to the Ethernet switch controller; identifying a request body of the communication request and a target node, where the target node is one of the plurality of chassis nodes; in response to the request body being an external node outside the server chassis, authenticating the request body, and communicating with the target node by means of a first communication mode in response to the authentication passing; and communicating with the target node by means of a second communication mode in response to the request body being the chassis node.

### BRIEF DESCRIPTION OF THE DRAWINGS

FIG. 1 is a schematic diagram of an application scenario of one or more embodiments of a node management method of a server chassis according to the present application;

FIG. 2 is a schematic structural diagram of one or more embodiments of a node management apparatus of the server chassis according to the present application;

FIG. 3 is a schematic structural diagram of some embodiments of the server chassis according to the present application;

FIG. 4 is a flow diagram of some embodiments of the node management method of the server chassis according to the present application;

FIG. 5 is a flow diagram of some embodiments of the node management method of the server chassis according to the present application;

FIG. 6 is a schematic structural diagram of some embodiments of the server chassis according to the present application;

FIG. 7 is a flow diagram of further some embodiments of the node management method of the server chassis according to the present application;

FIG. 8 is a flow diagram of still some embodiments of the node management method of the server chassis according to the present application; and

FIG. 9 is a schematic structural diagram of one or more embodiments of a computer device according to the present application.

### DETAILED DESCRIPTION

In order to make objectives, technical solutions, and advantages of the present application clearer, the present application will be described in detail below in conjunction with the accompanying drawings and the embodiments. It is understood that the embodiments described herein are merely used for explaining the present application, instead of limiting the present application.

In related technologies, communications between server chassis nodes usually has problems, such as slow communication rate, poor stability and poor scalability. In one or more embodiments, the server chassis communication is generally implemented based on an I2C bus, and an IPMB transmission rate is generally 100 K to 400 K, which is significantly lower than one hundred megabyte and gigabit of network transmission rate. Moreover, I2C-based IPMB is prone to abnormal transmission due to path interference or problems of a software library. Meanwhile, the communication between two nodes may need to exclusively occupy an I2C bus. If a plurality of nodes access each other, a lot of I2C bus resources need to be occupied, thus easily leading to poor scalability in the server chassis.

In the related technologies, the communication mode between the server chassis nodes may also be a direct connection through a baseboard management controller (BMC) dedicated port network. If so, problems such as occupying a BMC dedicated port network and poor scalability may be caused. In one or more embodiments, the BMC dedicated port is generally an out-of-band management channel, and the BMC dedicated port is easy to conflict with the out-of-band management function if applied between nodes inside the server for communication, thus affecting the out-of-band management function. BMC generally includes one dedicated port and may not be able to directly communicate with a plurality of nodes.

To solve a problem that a node management method in a server chassis is unreasonable in the related technologies, the present application provides a node management method of a server chassis, a node management apparatus of a server chassis, a server chassis, a computer device, and a computer-readable storage medium. The present application will be described in detail below.

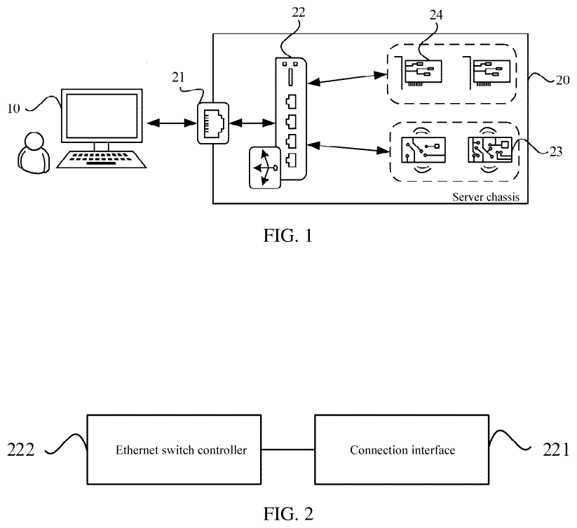

Referring to FIG. 1, which is a schematic diagram of an application scenario of one or more embodiments of the node management method of the server chassis according to the present application.

In one or more embodiments, an external node 10, such as a client-end device is in communication connection with a server chassis 20. The external node 10 refers to a node located outside the server chassis 20. The external node 10 may be, but is not limited to, various personal computers, laptops, smartphones, tablet computers, and portable wearable devices. In one or more embodiments, the server chassis 20 may refer to a stand-alone server. A plurality of stand-alone servers may form a server cluster. The server chassis 20 may have the capabilities of responding to a service request, undertaking a service, guaranteeing a service, and the like through an internal node.

In one or more embodiments, the external node 10 may be connected to the server chassis 20 through a connector 21 of a communication lead-out terminal of the server chassis 20. For example, the connector 21 of the communication lead-out terminal may be a Registered Jack 45 (RJ45) or the like, which is beneficial to improving the stability of communication between the external node 10 and the server chassis 20. Further, only the connector 21 of the communication lead-out terminal of the server chassis 20 may be directly visible from the outside.

Further, the server chassis may include chassis nodes and a node management apparatus 22 of the server chassis.

The chassis nodes refer to nodes located inside the server chassis. The chassis nodes may include a plurality of motherboard nodes 23 and at least one network card node 24. As illustrated and exemplified in FIG. 1, the chassis nodes of the server chassis 20 may include two motherboard nodes 23 and two network card nodes 24. It should be noted that the numbers of the motherboard nodes 23 and the network card nodes 24 illustrated and exemplified in FIG. 1 are used to illustrate the embodiment, rather than strictly limiting the number of the chassis nodes in the embodiment. For example, in one or more embodiments, the number of the motherboard nodes 23 may be two, and the number of the network card nodes 24 may be one; or a larger number of motherboard nodes 23 and network card nodes 24, which will not be described here.

For example, due to the emergence of high-performance central processing units (CPUs) such as Xeon processors (such as Birch Stream, etc.) at the present, the design of the single-motherboard node (one CPU) has become one of the current mainstreams. However, in terms of server utilization efficiency, a single-node server equipped with an intelligent network card for server management may be very wasteful from the perspective of Total Cost of Ownership (TCO). Therefore, designs such as putting two single-node motherboards in one chassis are derived, and at the same time, an intelligent network card is placed in the chassis again. Two node motherboards managed by one intelligent network card may implemented through the Multihost function of the intelligent network card.

Meanwhile, the design of reserving one node to be equipped with one intelligent network card may also be carried out further. Then, two motherboard nodes and two intelligent network cards are included inside the server chassis. As is well known, an intelligent network card may also be regarded as a small server, and may be considered equivalent to a node. It may be considered that the two motherboard nodes and two network card nodes included inside the server chassis have a great challenge for the server management.

The node management apparatus 22 of the server chassis is connected to the chassis nodes and the external node outside the server chassis. The node management apparatus of the server chassis may be as described in the embodiments below. The operation principle may refer to the node management method of the server chassis described below, and will not be described here.

Referring to FIG. 2, which is a schematic structural diagram of one or more embodiments of a node management apparatus of a server chassis according to the present application.

In one or more embodiments, the node management apparatus of the server chassis includes a connection interface 221 and an Ethernet switch controller 222.

The connection interface 221 is configured to connect an external node. In one or more embodiments, the connection interface 221 may be a connector of a communication lead-out terminal of the server chassis. In some embodiments, the connection interface 221 may be a port through which the Ethernet switch controller is connected to the connector of the communication lead-out terminal, i.e., a connector port mentioned below, which will not be limited here.

The Ethernet switch controller 222 is provided in the server chassis and is connected to the connection interface 221. The Ethernet switch controller 222 is configured to: acquire a communication request, where the server chassis further includes a plurality of chassis nodes connected to the Ethernet switch controller 222; identify the request body and the target node of the communication request, where the target node is one of the plurality of chassis nodes; communicate with the target node by means of a first communication mode in response to the request body being the external node outside the server chassis; and communicate with the target node by means of a second communication mode in response to the request body being the chassis node.

In one or more embodiments, the Ethernet switch controller may be a LAN Switch controller or the like, which will not be limited here.

Thus, it may be seen that the node management apparatus of the server chassis adds the Ethernet switch controller inside the server chassis, and the node management is achieved by using the Ethernet switch controller, so as to process flexible scalability, thus helping to flexibly manage the chassis nodes inside the server chassis. At the same time, in one or more embodiments, at least part of bus resources may also be released to facilitate reducing occurrence of insufficient bus resources. The chassis nodes in the server chassis are connected through the network, which is also beneficial to improving a data transmission rate and communication efficiency, thus improving management efficiency of the node server. Meanwhile, different response strategies are provided for the external node and the chassis nodes serving as the request bodies, and the external node is authenticated when serving as the request body, which is conducive to improving communication security of the server chassis, and then improving communication reliability of the chassis node.

Meanwhile, in one or more embodiments, more focus is placed on security and a flexible management of each management unit inside the server, and only the connector of the communication lead-out terminal may be directly visible to the external node. It is determined whether the chassis node belongs to the first node or the second node, and whether the chassis node may be visible from the outside, to achieve the security management by configuring the Ethernet switch controller. Meanwhile, each chassis node inside the server chassis may also perform the communication between internal nodes, which may achieve the flexible management of the internal nodes.

The limitation of the node management apparatus of the server chassis may refer to the limitation of the node management method of the server chassis below, which will not be described here. Each module in the node management apparatus of the server chassis described above may be fully or partially implemented by software, hardware, and a combination thereof. The above-mentioned modules may be embedded into or independent of the processor in the computer device in a form of hardware, or be stored in the memory of the computer device in a form of software, for ease of the processor to call and execute the corresponding operation of the above-mentioned modules.

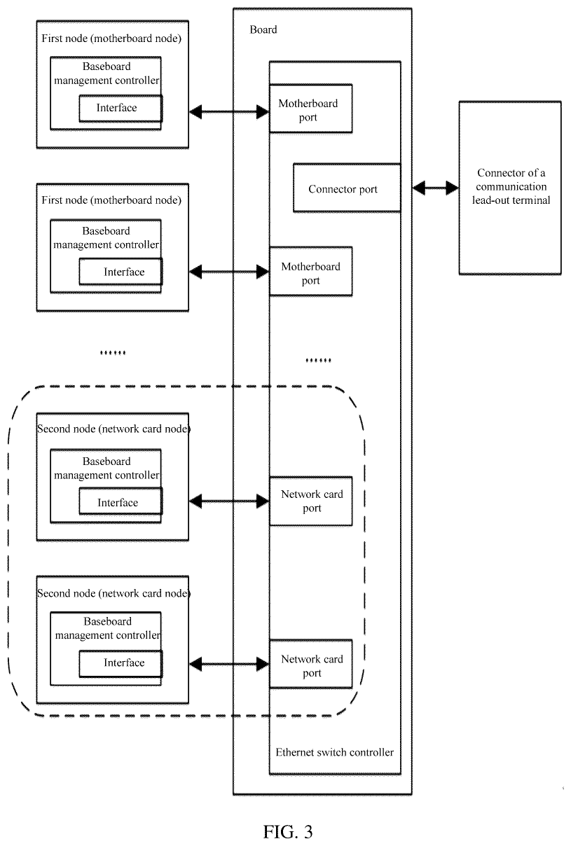

Referring to FIG. 3, which is a schematic structural diagram of some embodiments of a server chassis according to the present application. An internal structure of the server chassis in the present application will be described in detail below.

In one or more embodiments, the chassis nodes include a plurality of first nodes and at least one second node, the first nodes being connected to the second node.

The first nodes are nodes visible to the external node outside the server chassis, and the second node is a node hidden relative to the external node. In one or more embodiments, the chassis nodes that may be exposed to the outside of the server chassis may be reduced by setting the first nodes visible to the external node and the second node hidden relative to the external node, which is beneficial to improving the security of the server chassis, and may also plan the communication request delivery mode reasonably to reduce the communication burden. Meanwhile, in one or more embodiments, the external node serving as the request body will also be authenticated, which may reduce the risk of establishing a communication connection between the server chassis and a risky external node, and reduce the risk of the server chassis being easily attacked by a network, thus helping to improve the reliability and security of a communication process, and then improving the reliability and stability of the server chassis.

Further, the Ethernet switch controller may include a first port, a second port, and a connector port. The first port is connected to the first node. The second port is connected to the second node. The connector port is connected to the connector of the communication lead-out terminal connected to the Ethernet switch controller.

In one or more embodiments, the second port may be configured to be in a same virtual local area network; and/or, data isolation may be performed between the second port and the connector port through port isolation in local area network switching, thus controlling the data relatively reliably, and helping to achieve the data security.

In one or more embodiments, the first nodes may be motherboard nodes inside the server chassis. The second node may be a network card node inside the server chassis. Correspondingly, the Ethernet switch controller may include a motherboard port, a network card port, and a connector port. In other words, the first port may include a motherboard port, and the second port may include a network card port. The motherboard port is connected to the motherboard node. The network card port is connected to the network card node. The connector port is connected to the connector of the communication lead-out terminal connected to the Ethernet switch controller.

Still further, the Ethernet switch controller may further include an idle port. The idle port may be connected to a newly added chassis node or a chassis node migrated from a port of another Ethernet switch or the connector of the communication lead-out terminal, so as to improve the scalability of the server chassis. At the same time improve the convenience of migrating the chassis nodes inside the server chassis, thereby improving the scalability of node communication management while helping to improve the reliability and stability of the server chassis.

Referring to FIG. 4, which is a flow diagram of some embodiments of the node management method of the server chassis according to the present application.

S301: acquiring, by an Ethernet switch controller provided in a server chassis, a communication request, where the server chassis further includes a plurality of chassis nodes connected to the Ethernet switch controller.

In one or more embodiments, the communication request may be sent to the chassis nodes of the server chassis by the external node or the chassis nodes. The communication request may be understood macroscopically, may include an action of requesting to establish a communication connection, communication data, service request, and the like, and is not limited here.

S302: identifying a request body of the communication request and a target node, where the target node is one of the plurality of chassis nodes.

In one or more embodiments, a node that sends the communication request to the Ethernet switch controller is identified, and the node serves as a request body. The node with which the communication request wishes to communicate may also be identified, and serves as the target node.

S303: in response to the request body being an external node outside the server chassis, authenticating the request body, and communicating with the target node by means of a first communication mode in response to authentication passing; and communicating with the target node by means of a second communication mode in response to the request body being the chassis node.

In one or more embodiments, it is considered that a current communication request may have certain risks in response to identifying that the request body is an external node outside the server chassis, and the request body may be authenticated to verify whether or not the request body has authority to communicate with the chassis node. It may be considered that the external node may be trusted in response to the external node serving as the request body passing the authentication, the risk of communication with the external node is relatively small, and the external node is relatively reliable, therefore the request body is enabled to communicate with the target node through the first communication mode. Thus, when the external node communicates with the chassis nodes, the security and reliability of the communication process may be effectively improved.

Meanwhile, it may be considered that the communication risk inside the server chassis is relatively small in response to identifying that the request body is a chassis node inside the server chassis, that is, the communication occurs inside the server chassis, and it is not necessary to authenticate the request body. The request body is enabled to communicate with the target node by means of the second communication mode, which may reduce the authentication process and the computational cost of the communication process, thereby improving the communication efficiency.

The communication efficiency of the server chassis may be improved while helping to ensure the security and reliability by planning the response strategies for the external node and the chassis nodes serving as the request bodies, respectively.

To this end, in one or more embodiments, the Ethernet switch controller is added inside the server chassis, and the node management is achieved by using the Ethernet switch controller, so as to process the flexible scalability, thus helping to flexibly manage the chassis nodes inside the server chassis, and at the same time helping to improve the data transmission rate and the communication efficiency, thereby improving the management efficiency of the node server. Meanwhile, different response strategies are provided for the external node and the chassis nodes serving as the request bodies, and the external node is authenticated when serving as the request body, which is conducive to improving the communication security of the server chassis, and then improving the communication reliability of the chassis nodes.

Meanwhile, in one or more embodiments, the chassis nodes inside the server chassis also communicate with each other through the Ethernet switch controller. In other words, in one or more embodiments, a network communication is performed between the chassis nodes located within a same server chassis. Compared with the conventional bus communication mode between the chassis nodes in the server chassis, in the node management method of one or more embodiments, a network communication is provided between the chassis nodes, which may significantly improve the communication rate, also simplify the complicated operation generated when the chassis nodes are expanded/deleted, improve the processing efficiency when the chassis nodes change, is also beneficial to reducing occupation of the bus and/or the BMC dedicated port, reducing the risk of communication abnormality, thus improving the scalability of node communication management while improving the reliability and stability of the server chassis.

Further, as illustrated and exemplified in FIG. 3, in one or more embodiments, the chassis nodes include the first nodes and at least one second node. The first nodes are nodes visible to the external node, and the second node is a node hidden relative to the external node.

That is, in one or more embodiments, considering the communication security of the server chassis, the chassis nodes are divided into an internal network and an external network, communication between the internal network devices may not require to be authenticated, and the external network needs to be authenticated to access the internal network devices. At the same time, the chassis nodes that may directly communicate with the external node may be reduced, which is beneficial to further improving the security and reliability of communication.

In one or more embodiments, the first nodes may include a motherboard node. The second node may include a network card node. The Ethernet switch controller includes a network card port, a motherboard port, and a connector port.

The network card port is a port through which the Ethernet switch controller is connected to the network card node; the motherboard port is a port through which the Ethernet switch controller is connected to the motherboard node; the connector port is a port through which the Ethernet switch controller is connected to the connector of the communication lead-out terminal, and the connector of the communication lead-out terminal is configured to connect the external node.

Still further, the network card port is configured to be in a same virtual local area network, and the connector port communicates with the motherboard port. And/or data isolation is performed between the second port and the connector port through port isolation in local area network switching.

That is, in one or more embodiments, considering the communication security of the server chassis, the chassis nodes are divided into an internal network and an external network, communication between the internal network devices may not require to be authenticated, and the external network needs to be authenticated to access the internal network devices. In one or more embodiments, the motherboard node may serve as the first node and the network card node may serve as the second node. If so, data may be controlled relatively reliably in a manner of creating a virtual local area network and/or port isolation, which is beneficial to achieving data security.

In one or more embodiments, the server chassis may be configured as two division modes of supporting the creation of the virtual local area network and the port isolation. The division mode indicated by the configuration instruction may be switched by acquiring the configuration instruction of the user; in some embodiments, the division mode that is more suitable for the current scenario may be selected through reinforcement-based learning models and other modes, and no limitations are made here.

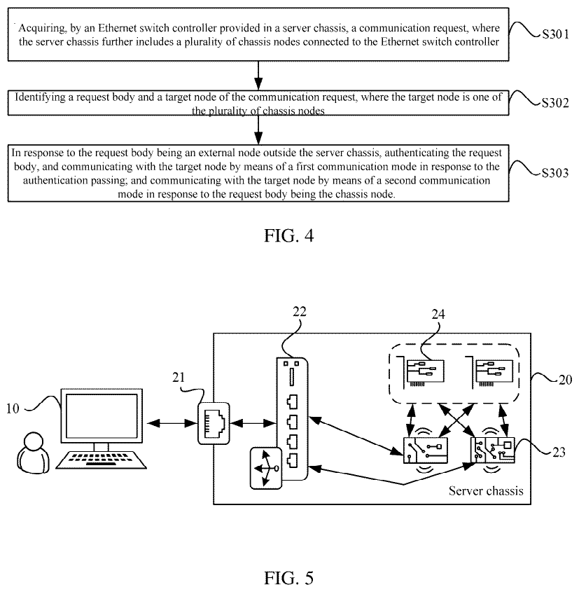

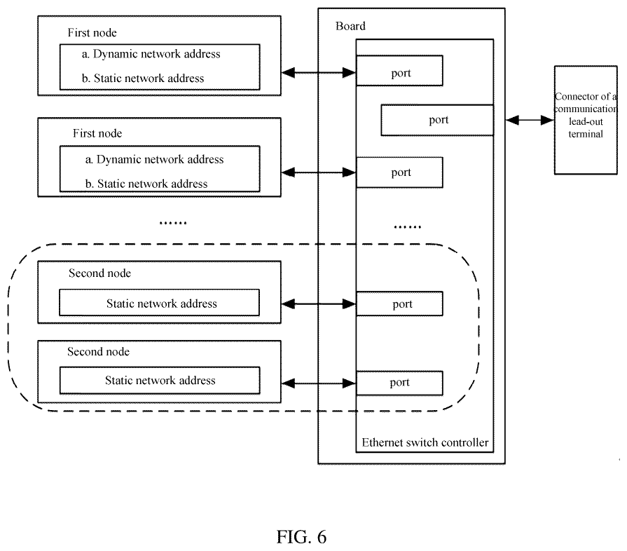

Referring to FIGS. 5 and 6 in conjunction, FIG. 5 is a flow diagram of some embodiments of the node management method of the server chassis according to the present application; and FIG. 6 is the schematic structural diagram of some embodiments of the server chassis according to the present application.

In one or more embodiments, the network address of each of the first nodes includes a static network address and a dynamic network address. The dynamic network address of the first node is obtained by static allocation and/or dynamic host configuration protocol. A network address of the second node includes a static network address.

Referring still to FIG. 5. The implementation of, in response to the external node serving as the request body and the target node being the second node, authenticating the request body, and communicating with the target node by means of the first communication mode in response to the authentication passing will be described in detail below.

In one or more embodiments, the Ethernet switch controller may send the communication request to one of the first nodes in response to receiving the communication request from the external node, and one of the first nodes receiving the communication request may serve as a forwarding node. Since the target node is a node hidden relative to the external node and may not directly communicate with the external node, the forwarding node means that the first node is not the target node of the communication request, but plays a role in forwarding the communication request to the second node serving as the target node.

The forwarding node and/or the target node may authenticate the request body, and whether or not the external node serving as the request body has the authority for access, communication and the like is verified. That is, the chassis node that authenticates the request body may be the first node serving as the forwarding node; in some embodiments, the chassis node that authenticates the request body may be the second node serving as the target node; in some embodiments, the chassis node that authenticates the request body may be the first node serving as the forwarding node and the second node serving as the target node, to authenticate the request body, respectively.

In one or more embodiments, the request body may be authenticated through one or a combination of a plurality of methods, such as an identity identifier, a key, a seal, a user biometric feature and a dynamic password, which will not be described here.

It may be considered that the request body is relatively trusted and reliable in response to the request body passing the authentication, so the forwarding node may forward the communication request to the target node, and the target node is enabled to receive the communication request. In response to the request body failing to pass the authentication, the communication request of the request body is rejected and/or relevant information is fed back to the user.

In one or more embodiments, the chassis nodes that may be exposed to the outside of the server chassis may be reduced by dividing the first node and the second node, which is beneficial to improving the security of the server chassis, and may also plan the communication request delivery mode reasonably to reduce the communication burden. Meanwhile, in one or more embodiments, the external node serving as the request body will also be authenticated, which may reduce the risk of the server chassis being easily attacked by a network, thus helping to improve the reliability and security of the communication process, and then improving the reliability and stability of the server chassis.

For example, both the forwarding node and the target node may authenticate the request body, respectively, thereby further improving the reliability of the authentication process through the dual authentication, and then helping to ensure the reliability and security of the communication process.

In one or more embodiments, the forwarding node may verify the first identity identifier of the request body in response to the Ethernet switch controller forwarding the communication request to the forwarding node. The first identity identifier may carry identity information that may be identified by the forwarding node, such as a user login name, a key, and network address information.

The forwarding node may communicate with the target node by means of a third communication mode in response to the first identity identifier passing the verification. The forwarding node may reject the communication request of the request body and/or feed back to the user that the request body fails to pass the verification of the first identity identifier in response to the first identity identifier failing to pass the verification.

In one or more embodiments, the third communication mode may include: acquiring interface information of the request body; querying transfer configuration information, and acquiring interface information of the target node matched with the interface information of the request body, where the transfer configuration information includes pre-configured interface information of various first nodes, the second node, and the external node, as well as interface information of the target node when the first nodes, the second node, and the external node each serve as the request body; and the forwarding node communicating with the target node based on the interface information of the target node.

That is, the communication mode between the first node serving as the forwarding node and the second node serving as the target node may be different from that between the first node serving as the request body and the second node serving as the target node described below. If so, the occupation of the same communication resources by different communication scenarios is reduced by reasonably planning the communication transfer process inside the server chassis, which is beneficial to improving the rationality of communication management between the nodes, and further beneficial to improving the stability of the server chassis.

The forwarding node sends the communication request from the request body to the target node by means of the third communication mode, and the target node verifies the second identity identifier of the request body. Determining that the authentication passes in response to the second identity identifier passing the verification. In response to the second identity identifier failing to pass the verification, the target node may reject the communication request of the request body and/or feed back to the user that the request body fails to pass the verification of the second identity identifier.

Further, the first identity identifier and the verification of the forwarding node may be periodically updated at intervals with a first preset duration. The second identity identifier and the verification of the target node may be periodically updated at intervals with a second preset duration. Meanwhile, the second preset duration is longer than the first preset duration. In other words, the updating frequency of the first identity identifier may be higher than that of the second identity identifier, thus reasonably planning the updating frequencies of the first identity identifier and the second identity identifier, and reasonably balancing and managing the computing resources as well as the security and reliability of the server chassis. Meanwhile, the request body is first authenticated by the first identity identifier with higher updating frequency, which is beneficial to improving the effectiveness of authentication, may screen out the external node having no communication authority in the early stage, and may reduce the operation of secondary verification, so as to improve the communication response efficiency while reducing the communication computation cost.

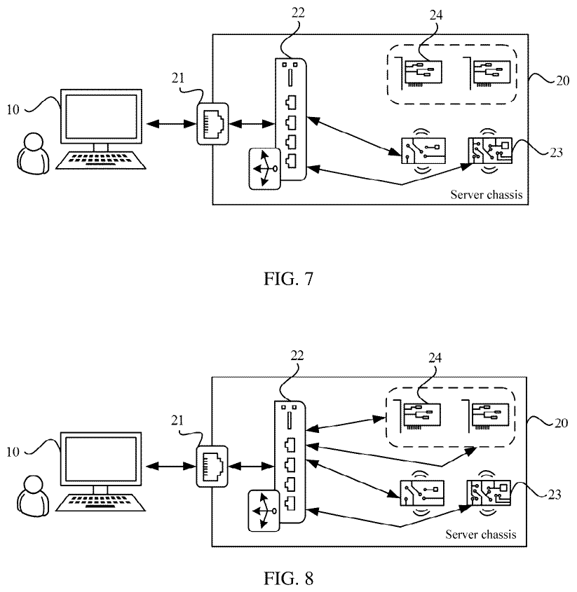

Referring to FIG. 7, which is a flow diagram of further some embodiments of a node management method of a server chassis according to the present application. The implementation of, in response to the external node serving as the request body and the target node being the first node, authenticating the request body and communicating with the target node by means of a first communication mode in response to the authentication passing will be described in detail below.

In one or more embodiments, the connector port of the Ethernet switch controller receives the communication request, and the connector port is a port connected to the external node. The Ethernet switch controller sends the communication request from the connector port to the port connected to the first node serving as the target node.

The target node verifies the identity of the request body in response to the communication request input in a port to which the target node is connected to the Ethernet switch controller. The communication request is accepted in response to the request body passing the identity verification. In response to the request body failing to pass the identity verification, the communication request of the request body is rejected and/or relevant information is fed back to the user.

In one or more embodiments, the external node serving as the request body requests communication with the first node, and the first node is a node visible to the external node, so the intervention of the second node hidden relative to the external node may be reduced, thus helping to improve the reliability of the communication process.

Referring to FIG. 8, which is a flow diagram of still some embodiments of the node management method of the server chassis according to the present application.

The implementation of authenticating the request body when the chassis node serves as the request body and the target node is also the chassis node and communicating with the target node by means of a first communication mode in response to the authentication passing will be described in detail below.

In one or more embodiments, the baseboard management controller provided in the request body monitors operation information of the request body, and the operation information includes at least one of temperature information, power consumption information, and resource utilization.

The baseboard management controller performs data processing on the operation information, to obtain the communication data monitored by the baseboard management controller.

Further, the request body may send the communication data to the Ethernet switch controller at an opportunity complying with the transmission of the communication data. In one or more embodiments, the communication data may include at least one of temperature information, power consumption information, and resource utilization.

The Ethernet switch controller broadcasts the communication data carrying a verified network address to the chassis node, where the verified network address includes a network address of the request body and/or a network address of the target node, and the target node is configured to acquire the communication data when the verified network address is identified.

The target node acquires the communication data in response to identifying the network address.

It may be seen that, in one or more embodiments, the chassis nodes may communicate with each other through the network, which may significantly improve the communication efficiency compared with the communication mode through the bus inside the server chassis, and is also beneficial to improving the security and stability of the server chassis. At the same time, the communication management performed through the Ethernet switch controller may improve the scalability, thus helping to improve the flexibility of the node management mode.

It should be understood that, although various steps in the flowcharts of FIGS. 4 to 5 and FIGS. 7 to 8 are successively displayed according to the indication of an arrow, those steps are not necessarily implemented according to the order indicated by the arrow. Unless otherwise specified herein, the implementation of those steps is not strictly limited by the order, and those steps may be implemented in other orders. Moreover, at least partial steps in FIGS. 4 to 5 and FIGS. 7 to 8 may include a plurality of sub-steps or a plurality of stages, these sub-steps or stages are not necessarily implemented or completed at the same time, and may be implemented at different times. The implementation order of these sub-steps or stages are not necessarily performed successively, but implemented in turns or alternately with other steps or the sub-steps or stages of other steps.

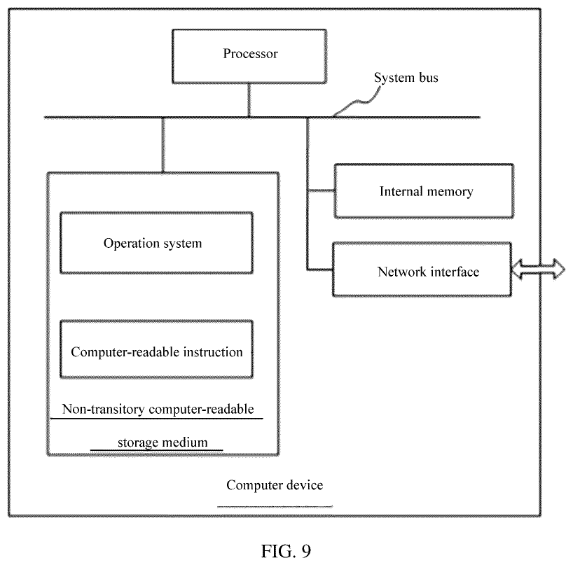

Referring to FIG. 9, which is a schematic structural diagram of one or more embodiments of a computer device according to the present application.

In one or more embodiments, the computer device may be a server, and the internal structure diagram of the server may be illustrated and exemplified in FIG. 9.

The computer device includes one or more processors connected through a system bus, a memory managed with the one or more processors, and a network interface. The processor of the computer device is configured to provide computation and control abilities. The memory is configured to store a computer-readable instruction. The memory of the computer device includes a non-transitory storage medium, and an internal memory. The non-transitory storage medium stores an operation system, a computer-readable instruction, and a database. The internal memory provides an environment for the operation of the operation system and computer-readable instruction in the non-transitory storage medium. The network interface of the computer device is configured to connect and communicate with an external terminal through the network. The computer-readable instruction, when executed by a processor, implements a node management method of a server chassis.

Those skilled in the art may understand that the structure shown in FIG. 9 is merely a block diagram of some structures related to the solution of the present application, and does not constitute a limitation to the computer device to which the solution of the present application is applied. The computer device may include more or fewer components than those shown in the figure, or a combination of some components, or an arrangement of different components.

In one or more embodiments, a computer device is provided, including a memory, one or more processors, and a computer-readable instruction stored on the memory and capable of running on the processor, and the processor implements the following steps when executing the computer-readable instruction:

S301: acquiring, by an Ethernet switch controller provided in a server chassis, a communication request, where the server chassis further includes a plurality of chassis nodes connected to the Ethernet switch controller.

S302: identifying a request body and a target node of the communication request, where the target node is one of the plurality of chassis nodes.

S303: in response to the request body being an external node outside the server chassis, authenticating the request body, and communicating with the target node by means of a first communication mode in response to the authentication passing; and communicating with the target node by means of a second communication mode in response to the request body being the chassis node.

Those of ordinary skill in the art may understand that all or partial processes implementing the above embodiments may be completed in a manner that the related hardware is instructed through a computer-readable instruction, the computer-readable instruction may be stored in a non-volatile computer reading storage medium, and the computer-readable instruction may include the process of the embodiments of the above method when being executed. Any reference to the memory, storage, database or other media used in each embodiment provided by the present application may include a non-volatile and/or volatile memory. The non-volatile memory may include a read-only memory (ROM), a programmable ROM (PROM), an erasable PROM (EPROM), an electrically EPROM (EEPROM) or a flash memory. The volatile memory may include a random access memory (RAM) or an external cache. As an illustration rather than a limitation, RAM may be obtained in a plurality of forms, such as static (SRAM), dynamic RAM (DRAM), a synchronous DRAM (SDRAM), double data rate SDRAM (DDRSDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM), etc.

All the technical features of the above embodiments may be combined randomly. For the sake of brevity, all possible combinations of all the technical features in the above embodiments are not described. However, these technical features shall all be considered to fall within the scope of this specification as long as there is no contradiction in their combinations.

The above-mentioned embodiments only express some implementation modes of the present application and are specifically described in detail and not thus understood as limitations to the patent scope of the present application. It should be pointed out that those of ordinary skill in the art may further make a plurality of transformations and improvements without departing from the concept of the present application and all of these fall within the scope of protection of the present application.

1. A node management method of a server chassis, wherein the node management method comprises:
acquiring, by an Ethernet switch controller provided in a server chassis, a communication request, wherein the server chassis further comprises a plurality of chassis nodes connected to the Ethernet switch controller;
identifying a request body and a target node of the communication request, wherein the target node is one of the plurality of chassis nodes;
in response to the request body being an external node outside the server chassis, authenticating the request body, and communicating with the target node by means of a first communication mode in response to authentication passing; or
communicating with the target node by means of a second communication mode in response to the request body being the chassis node.

2. The node management method according to claim 1, wherein the plurality of chassis nodes comprise a plurality of first nodes and at least one second node, wherein the plurality of first nodes are nodes visible to the external node, and the at least one second node is a node hidden relative to the external node;
in response to the target node being the at least one second node, authenticating the request body, and communicating with the target node by means of the first communication mode in response to the authentication passing comprises:
sending, by the Ethernet switch controller, the communication request to one of the plurality of first nodes, wherein the one of the plurality of first nodes serves as a forwarding node;
authenticating, by at least one of the forwarding node or the target node, the request body; and
forwarding, by the forwarding node, the communication request to the target node in response to the authentication passing.

3. The node management method according to claim 2, wherein authenticating, by at least one of the forwarding node or the target node, the request body comprises:
verifying, by the forwarding node, a first identity identifier of the request body;
communicating, by the forwarding node, with the target node by means of a third communication mode in response to the first identity identifier passing first verification;
verifying, by the target node, a second identity identifier of the request body; and
determining that the authentication passes in response to the second identity identifier passing second verification.

4. The node management method according to claim 3, wherein communicating, by the forwarding node, with the target node by means of the third communication mode comprises:
acquiring first interface information of the request body;
querying transfer configuration information, and acquiring second interface information of the target node matched with the first interface information of the request body, wherein the transfer configuration information comprises pre-configured interface information of various of the plurality of first nodes, the at least one second node, and the external node, as well as third interface information of the target node when the various of the plurality of first nodes, the at least one second node, and the external node each serve as the request body; and
communicating, by the forwarding node, with the target node based on the second interface information of the target node.

5. The node management method according to claim 3, wherein the node management method comprises:
periodically updating the first identity identifier and the first verification of the forwarding node at intervals with a first preset duration; and
periodically updating the second identity identifier and the second verification of the target node at intervals with a second preset duration, wherein the second preset duration is longer than the first preset duration.

6. The node management method according to claim 2, wherein in response to the target node being the one of the plurality of first nodes, authenticating the request body, and communicating with the target node by means of the first communication mode in response to the authentication passing comprises:
receiving, by a connector port of the Ethernet switch controller, the communication request, wherein the connector port is a first port connected to the external node;
sending, by the Ethernet switch controller, the communication request from the connector port to a second port connected to the target node;
performing identity verification, by the target node, on the request body in response to the communication request being input in the second port at which the target node is connected to the Ethernet switch controller; and
accepting the communication request in response to the request body passing the identity verification.

7. The node management method according to claim 1, wherein communicating with the target node by means of the second communication mode in response to the request body being the chassis node comprises:
sending, by the request body, communication data to the Ethernet switch controller;
broadcasting, by the Ethernet switch controller, the communication data carrying a verified network address to the chassis node, wherein the verified network address comprises at least one of a network address of the request body or a network address of the target node, and the target node is configured to acquire the communication data when the verified network address is identified; and
acquiring, by the target node, the communication data in response to identifying the verified network address.

8. The node management method according to claim 7, wherein the communication data comprises at least one of temperature information, power consumption information, or resource utilization; and the node management method comprises:
monitoring, by a baseboard management controller provided on the request body, operation information of the request body, wherein the operation information comprises at least one of the temperature information, the power consumption information, or the resource utilization; and
performing, by the baseboard management controller, data processing on the operation information, to obtain the communication data monitored by the baseboard management controller.

9. The node management method according to claim 7, wherein authenticating the request body comprises steps of:
determining a forwarding node for forwarding the communication request to the target node; and
authenticating the request body by the forwarding node and the target node, respectively.

10. A node management apparatus of a server chassis, wherein the node management apparatus comprises:
a connection interface, configured to connect an external node; and
an Ethernet switch controller, provided in the server chassis, connected to the connection interface, and configured to:
acquire a communication request, wherein the server chassis further comprises a plurality of chassis nodes connected to the Ethernet switch controller;
identify a request body and a target node of the communication request, wherein the target node is one of the plurality of chassis nodes;
communicate with the target node by means of a first communication mode in response to the request body being the external node outside the server chassis; and
communicate with the target node by means of a second communication mode in response to the request body being the chassis node.

11. A server chassis, wherein the server chassis comprises:
a plurality of chassis nodes, comprising a plurality of motherboard nodes and at least one network card node; and
a node management apparatus of the server chassis, connected to the plurality of chassis nodes and an external node outside the server chassis, and the node management apparatus comprising:
a connection interface, configured to connect the external node; and
an Ethernet switch controller, provided in the server chassis, connected to the connection interface, and configured to:
acquire a communication request, wherein the plurality of chassis nodes connected to the Ethernet switch controller;
identify a request body and a target node of the communication request, wherein the target node is one of the plurality of chassis nodes;
communicate with the target node by means of a first communication mode in response to the request body being the external node outside the server chassis; and
communicate with the target node by means of a second communication mode in response to the request body being the chassis node.

12. The server chassis according to claim 11, wherein the plurality of chassis nodes comprises a plurality of first nodes and at least one second node, the plurality of first nodes being connected to the at least one second node; wherein
the plurality of first nodes are nodes visible to the external node outside the server chassis, and the at least one second node is a node hidden relative to the external node.

13. The server chassis according to claim 12, wherein a network address of the plurality of first nodes comprises a first static network address and a dynamic network address, wherein the dynamic network address of the plurality of first nodes is obtained by at least one of static allocation or dynamic host configuration protocol; and
a network address of the at least one second node comprises a second static network address.

14. The server chassis according to claim 12, wherein the Ethernet switch controller comprises a first port, a second port, and a connector port;
the first port is connected to the plurality of first nodes, the second port is connected to the at least one second node, and the connector port is connected to a connector of a communication lead-out terminal connected to the Ethernet switch controller; and
the second port is configured to be in a virtual local area network; and data isolation is performed between the second port and the connector port through port isolation in local area network switching.

15. The server chassis according to claim 12, wherein the plurality of first nodes comprise a motherboard node, the at least one second node comprises a network card node;
the Ethernet switch controller comprises a motherboard port, a network card port, a connector port and an idle port; and
the motherboard port is connected to the motherboard node; the network card port is connected to the network card node; the connector port is connected to a connector of a communication lead-out terminal connected to the Ethernet switch controller; and the idle port is configured to connect a newly added chassis node or a chassis node migrated from a port of another Ethernet switch or the connector of the communication lead-out terminal.

16. The server chassis according to claim 11, wherein the external node is connected to the server chassis through a connector of a communication lead-out terminal of the server chassis.

17. The server chassis according to claim 16, wherein the connector of the communication lead-out terminal of the server chassis is directly visible from outsides of the server chassis.

18. The server chassis according to claim 11, wherein the server chassis comprises a plurality of internal chassis nodes, the plurality of internal chassis nodes communicating with each other through the Ethernet switch controller.

19. (canceled)

20. (canceled)

21. The server chassis according to claim 12, wherein the Ethernet switch controller comprises a first port, a second port, and a connector port;
the first port is connected to the plurality of first nodes, the second port is connected to the at least one second node, and the connector port is connected to a connector of a communication lead-out terminal; and
the second port is configured to be in a virtual local area network; or data isolation is performed between the second port and the connector port through port isolation in local area network switching.

22. The server chassis according to claim 21, wherein the server chassis is configured as two division modes of supporting a creation of the virtual local area network and the port isolation, and a suitable division for a current scenario is selected from the two division modes through reinforcement-based learning models.
